(19) United States
(12) Patent Application Publication
(10) Pub. No.: US 2026/0217518 A1
(43) Pub. Date: Jul. 30, 2026

(54) BEVERAGE PACKAGING EQUIPMENT, DOSING SYSTEM, AND METHODS FOR INFUSING BEVERAGES

(71) Applicant: AGTECH VI, LLC, St. Thomas (VI)

(72) Inventor: Angus RITTENBURG, Pennsburg, PA (US)

(21) Appl. No.: 19/151,790

(22) PCT Filed: Jan. 25, 2024
(86) PCT No.: PCT/US2024/012917

§ 371 Date: Jul. 29, 2025

Related U.S. Application Data
(60) Provisional application No. 63/483,163, filed on Feb. 3, 2023.

(51) Int. Cl. B67C 3/20; B67C 7/00

(52) U.S. Cl. CPC B67C 3/208; B67C 7/0086

(57) ABSTRACT

Methods and apparatus for injecting additives into sealed beverage containers (1). The methods include injecting additives into a sealed container through valve/grommets (3) to combine with the base beverage in the sealed beverage container to form an infused beverage. The automated machine (8) precisely injects additives into the sealed beverage containers that are previously packaged and sealed to form the infused beverage. The automated machine is self-contained and easily transportable which makes it possible to inject additives at secondary facilities after packaging of a beverage is completed in an initial facility.

### FIELD OF THE INVENTION

The subject matter of this invention relates to an automated machine that is used to create infused beverages by injecting an additive or ingredient into a previously sealed container.

### BACKGROUND OF THE INVENTION

Conventional beverage packaging equipment is used to fill containers with substances and permanently seal them with no means to alter the composition after initial packaging. The instant invention solves this problem by providing a means for changing the composition after initial packaging

Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The instant invention solves the problems associated with conventional beverage packaging systems by providing an automated machine that is able to precisely inject additives into containers that are previously packaged and hermetically sealed, thereby changing the composition. The automated machine is self-contained and easily transported which makes it possible to inject additives at secondary facilities after packaging is completed in an initial facility, the secondary facilities being remote from the initial facilities. In one embodiment, the automated machine can create an infused beverage composition in a traditional beverage container by injecting an additive through a valve/grommet.

In one embodiment, the inventive machine can be employed for introducing an additive via the grommet of the container disclosed in U.S. Pat. Nos. 10,246,250 and 10,865,036; the disclosure of the foregoing patents is hereby incorporated by reference in their entirety.

In another embodiment, the inventive machine is capable of dosing a plurality of containers in a single cycle.

In a further embodiment, the valve/grommet and the area adjacent to the valve/grommet (e.g., the end of the container into which the grommet was inserted) is exposed to UV light for a time and intensity sufficient to inhibit any active bacteria (or other biological contaminants) from entering the container via the valve/grommet.

The various aspects and embodiments of this disclosure can be used alone or in combinations with each other.

Other features and advantages of the present invention will be apparent from the following more detailed description, taken in conjunction with the accompanying drawings which illustrate, by way of example, the principles of the invention.

### BRIEF DESCRIPTION OF DRAWINGS

FIGS. 1a and 1b are a beverage container assembly comprising a container body, valve and an end.

FIG. 2 is a tray containing an array of 24 beverage containers.

FIGS. 3a, 3b, and 3c illustrate the process of inverting and transferring the array of beverage containers from a disposable tray to a positioning tray.

FIG. 4 shows an overview of the automated machine.

FIG. 5 shows an overview of the automated machine with several components hidden.

FIG. 6 shows an overview of the automated machine with several other components hidden.

FIG. 7 shows a cross section of a tray of beverage containers positioned on the automated machine.

FIGS. 8a and 8b show a detailed view of the dosing head with a tray of beverage containers positioned below.

FIG. 9 shows the dosing nozzles injecting additive through the dosing valves.

FIG. 10 shows a flow diagram of a basic dosing machine.

FIG. 11 shows a flow diagram of an alternative dosing machine with the ability to auto-dilute additives.

Wherever possible, the same reference numbers will be used throughout the drawings to represent the same parts.

### DETAILED DESCRIPTION OF THE INVENTION

The following definitions are provided to illustrate the various aspects and embodiments of this disclosure.

“Beverage” means a carbonated beverage comprising carbonated water, flavoring and optionally one or more additives. Examples of flavoring can comprise citrus, berry, mango, cherry, among other fruits. The additive can comprise additional compounds including at least one member selected from the group consisting of nicotine, caffeine, nutraceuticals, vitamins, and botanical extracts, such as rosemary, lavender, lemongrass, cannabinoids and cannabidiol (e.g., CBD and THC), and/or preservatives. While any suitable preservative could be used, specific examples include Sodium Benzoate or Potassium Sorbate. Alternatively, or in addition to the additional compound, the beverage container comprises at least one fermented or distilled spirit, such as vodka, gin, rum, tequila, whiskey, among others.

“Base beverage” means a beverage prior to inclusion of the additive.

“Infused beverage” or “infused beverage composition” means a beverage including the additive in the base beverage.

“Dosing” means a mechanized process for pressurized injection of an additive or other ingredient into a previously sealed container having a beverage therein. By dosing it is possible to package a beverage at one location, transport the packaged beverage to a second location and introduce an additive or other ingredient into the package beverage at the second location.

Broadly, the instant invention relates to an automated machine that is capable of precisely dosing an additive into a packaged container, such as a beverage can or bottle. The container can be made from a variety of materials including plastic, ceramic, or metal, among others. The container can be made through a variety of methods including blow molding, casting, deep drawing, among others. The container is manufactured to contain a means of allowing a fluid or gas into the container, while also providing a hermetic seal to eliminate the flow of liquid or gas out of the container.

In one embodiment, the container is a can including a container body that is drawn from a sheet of aluminum and an end or lid that is stamped from a sheet of aluminum. While any suitable material can be used, a preferred embodiment used a 3000 series aluminum for the container body and 5000 series aluminum for the end or lid. After filling, an end or lid is positioned on the container body such that the peripheral curl structure of the end is aligned with the container body flange. Both the end and the container body are mutually deformed to form the seam and hermetically seal the container. In this embodiment, the combination of container body and end or lid that are seamed together comprise a beverage container.

In one embodiment, the beverage container has a valve/grommet installed such that a gas or liquid can flow into the container, but gas or liquid cannot flow out of the container. By valve/grommet, as utilized herein, it is meant that the valve/grommet is a flow control device, such as a grommet, a valve or any other suitable liquid flow control device that, for example, permits flow of liquid in one direction. Several conventional valve/grommets are commercially available for charging beverage containers with gas or liquid, as will be understood by persons familiar with technology of charging beverage containers. One suitable valve/grommet includes the sealing grommet described in U.S. Pat. No. 6,729,362, which is hereby incorporated by reference in its entirety. Generally, an aperture is formed in the bottom end of the container body before the end is seamed onto the cylindrical container body. Because the aperture is formed in the unattached end, opposing tools have easy access to contact the upper and lower surfaces of the end. A valve/grommet can then be installed into the aperture from either the topside or underside of the end before seaming onto the container body (and before introducing the beverage into the container body). Typically, the valve/grommet is installed on the end of the beverage container which is opposite from the end that the beverage is dispensed.

In one embodiment, the container body comprising a valve/grommet is filled with liquid using conventional beverage can filling equipment, and an end or lid is then seamed onto the can to provide a seal. The filled beverage container can then be either consumed as is, or gas or liquid can be injected through the valve/grommet to produce an infused beverage inside the beverage container.

In one embodiment, the beverage container is filled with a composition that comprises carbonated water, flavoring, and a regulated ingredient packaged into a hermetically sealed beverage container. The amount of carbonated water can comprise 95% to about 99% of the beverage. The flavoring can vary as desired and can range from about 0.1% to about 0.5% of the beverage. The regulated ingredient can only be manufactured and stored in a facility with an appropriate state or federal license. The regulated ingredient is added to the beverage in a concentration range from about 0.01% to about 0.5%.

In one embodiment, the regulated ingredient comprised a liquid emulsion of botanical extract. The liquid emulsion is composed of a combination of water, surfactants, preservatives, and botanical extracts. It is to be understood that the regulated ingredient can comprise any liquid or gaseous composition.

In one embodiment, the beverage containers are initially filled and sealed in one facility and then transported to a second facility with the appropriate state or federal license to store and manufacture the regulated ingredient. In this embodiment, the first facility is a warehouse and production space designed and built with all the appropriate utilities required for high-rate beverage production including, but not limited to: three phase power, compressed gasses, refrigeration equipment, packaging equipment, and beverage quality laboratory equipment. The second facility is a laboratory, kitchen, retail, or office space, among other options, with limited physical space and utilities. In this embodiment the second facility has only 120v power and no beverage production equipment. The second facility also has a state or federal license to store and manufacture the regulated ingredient. In this embodiment, the first facility fills and seals the beverage containers with everything other than the regulated ingredient. The second facility uses the instant invention to inject the regulated ingredient through the valve/grommet to create the infused beverage. By way of example, in this embodiment, beverages container be produced in accordance with Michigan code 333.27961; Sec. 11; the disclosure of which is hereby incorporated by reference in its entirety.

In one specific aspect of these embodiments, the total amount of regulated ingredient to form an infused beverage can vary including greater than 0 to about 10 mg, about 0.5 to about 7.5 mg and, in some cases about 1 to about 3 mg, per 250 ml of beverage. In another specific aspect of these embodiments, the total amount of the regulated ingredient can range from about 0 to about 100 mg, about 2.5 to about 25 mg and, in some cases about 2.5 to about 5 mg, per 250 ml of beverage. In another specific aspect of these embodiments, the total amount of the regulated ingredient can range from about 0 to about 100 mg, about 2.5 to about 25 mg and, in some cases about 2.5 to about 5 mg, per 355 ml of beverage.

For some beverage formulations and additives, the presence of oxygen and, in particular, oxygen dissolved within the beverage, can have an undesired effect on taste, shelf-life, among other beverage characteristics. In some cases, the potency of certain additives are degraded as a result of oxidation from exposure to dissolved oxygen. One embodiment of the invention relates to using an inventive automated machine comprising an additive dosing system wherein the additive with tendency to oxidize can be added at the final point of distribution to eliminate degradation due time spent in supply chain and storage. The additive can be added immediately before sale, extending shelf life.

In one embodiment of the invention, the beverage containers are placed in trays that hold a defined number of beverage containers (e.g., twenty-four beverage containers). The trays are made to hold, for example, an array of containers four containers wide and six containers long. The trays can vary in size to accommodate a larger or smaller array or containers, or to accommodate different sized containers. The size of the array can vary from 2 to about 36 containers, 6 to about 24 containers, or in some cases 12 to about 24 containers. The size of the container can vary in diameter from about 1 inch to about 4 inches, 2 to 3 inches, or in some cases 2.1 to about 2.3 inches. The height of the containers can vary from 1 inch to about 8 inches, 4 inches to about 6.5 inches, or in some cases 4 to about 5 inches. As will be understood by persons familiar with production of beverage containers, common container diameters are known in the trade as slim, sleek, and standard, among others.

In one embodiment of the invention, the arrays of containers are first packaged into disposable trays at a first facility. The containers are loaded into the trays with the valve/grommet oriented downwards in the tray. The valve/grommet is oriented downward to protect the valve/grommets from collecting impurities including dust or other debris. The containers in trays are then palletized for transportation. In a preferred embodiment, a pallet will hold 150 trays of containers. The disposable trays can be produced from low-cost materials and are intended to be disposed of after the containers are removed. While any suitable material can be used, the disposable trays are made from cardboard in this preferred embodiment. After the containers are loaded into the disposable trays and palletized for transport, they are transported to a second facility containing the automated machine. In this embodiment, the arrays of containers are transferred into reusable positioning trays or orientable fixtures prior to being loaded into the automated machine. The reusable trays or orientable fixtures serve two functions: provide a means for inverting the containers such that the valve/grommets are facing upwards, and to provide a rigid fixture to repeatably constrain the containers. The reusable positioning tray mechanically constrains the array of containers in a known location on the tray so mechanisms inside the automated machine can mechanically interact with containers without complex systems to otherwise position the containers in a known location. The containers can be loaded into the trays manually or via an automated conveyor system.

In one embodiment of the invention, the automated machine has a conveyance that is a track that is designed to precisely locate the positioning tray on the automated machine. In one specific embodiment of the invention, the positioning tray comprises V-cut features on the downward side of the tray that interact with spherical features on the conveyance track to constrain the tray in five degrees of freedom. The sixth degree of freedom remains initially unconstrained in the machine such that the tray can be moved along the axis of the conveyance track. It is to be understood that any suitable mechanical constraint can be employed between the positioning tray and the conveyance track. The tray container be positioned on the conveyance track either manually or via an automated arrangement.

In one embodiment, an ionized air blower is used to remove dust and debris from the valve/grommet (and the area adjacent to the valve/grommet) on the container. In one specific embodiment of the invention, an electric fan and air ionizer is used to eliminate the need for a compressed air source to be connected to the automated machine. It is to be understood that any suitable means of removing debris from the valve/grommets can be employed including steam, compressed gas, solvent, or liquid solution.

In one embodiment, an ultraviolet light array is used to sterilize the valve/grommets prior to any gas or liquid being introduced into the beverage container. The ultraviolet light provides both specific wavelengths of light that destroy microorganisms as well as a means of ozone generation to further eliminate the presence of active microorganisms on the surface. It is to be understood that any suitable means of sterilizing the containers can be employed including steam, solvent, or liquid solution.

One embodiment of the invention relates to using vessels which are operationally positioned (e.g., placed inside the automated machine) to hold the additive or ingredients intended to be injected into the container. It is to be understood that any number of additive containers can be used. While any suitable material can be used, 316 stainless steel is used in this embodiment due to its inherent corrosion resistance to liquids and food safety compliance. Generally, food packaging materials can be chosen such that they are compliant with 21 CFR Parts 170-199. In one specific aspect of this embodiment, the total volume of an individual additive container can vary including greater than 0 to about 10 gallons, about 2 to about 8 gallons and, in some cases about 6 to about 8 gallons. The additive holding vessels are in fluid communication with the automated machine for dosing the contents of the additive holding vessel into the containers.

In one embodiment, variable stroke positive displacement pumps are used to inject precise different amounts of ingredients into the container (e.g., the positive displacement pumps pull the additive to be dosed from the holding vessels and convey the additive to a dosing head). It is to be understood that any means of ingredient injection can be employed including mechanical pumps or pressure differential, among others. Additionally, solenoid valves are used before and after the pump to control the flow of ingredients such that ingredients flow into the pump during aspiration, and ingredients can flow out of the pump during expiration. It is to be understood that any form of flow control can be used in place of solenoids including check valves. In the preferred embodiment, solenoid valves are used for more precise control over pump cycle volume where check valves are not suitable.

In one embodiment, a two-axis stage is used to position a dosing head comprising a plurality of valves, for example, four dosing valves onto the valve/grommets during injection of an ingredient. The dosing head interfaces with four valve/grommets at once to perform parallel dosing of four containers simultaneously. The dosing valves provide a seal with the valve/grommet and fluid path for ingredients to flow from the dosing pumps into the containers. The dosing head is first forcibly lowered onto the containers with enough pressure to adequately seal the dosing valves against the surface of the valve/grommets. The dosing pumps are then operated to create a positive pressure differential between the inside of the container and the ingredient which causes the ingredient to flow into the container. The dosing valves are spring loaded to provide a mechanical compliance that allows for adequate pressure to be applied to all four valve/grommets simultaneously despite inherent variation in the height of the containers. It is to be understood that the dosing head may contain any number of dosing valves to provide a means for injecting additives to multiple containers at once.

In one embodiment, pressure transducers are installed in series with each of the ingredient flow paths to the dosing valves to provide an in-line quality check. The pressure transducers measure pressure during the entire dosing cycle. The pressure transducer data can be used to detect some of the following abnormalities and used to ensure quality control:
Low initial pressure in the container indicates the hermetic seal of the container has been compromised
Low pressure during the dosing cycle indicates that the ingredient may not be flowing into the container
High pressure during the dosing cycle indicates that there is a clog in the systems somewhere.
No change in pressure during the dosing cycle indicates that the ingredient is not being pumped correctly.

In one embodiment, multiple positive displacement pumps are connected in parallel to a dosing valve. Multiple positive displacement pumps can be used if multiple additives are to be injected through a single valve/grommet at varying ratios. An additional positive displacement pump can also be employed in instances where the amount of additive to be injected into the container does not have sufficient volume or displacement to pass through the valve/grommet. In this case, a first pump can be used to pump a small amount of additive toward the valve/grommet, and an inert substance can be pumped using the second pump to flush the small amount of additive through the valve/grommet. For example, 20 microliters of botanical emulsion can first be pumped, then 1 ml of distilled water can be pumped to push the small amount of botanical emulsion through the valve/grommet and into the container.

In one embodiment, a continuous motion machine is used to dose the containers. The containers are conveyed into a carousel type mechanism wherein the containers are moved around the circumference of a rotating cylinder on pedestals that move up and down to move the container vertically against a dosing nozzle. The machine is designed such that one motor is required to rotate the carousel, and the pedestals and pumps are driven by mechanical interactions including gears, cam and follows, and pistons. This embodiment is favorable for high output machines or applications where timing of different machine motions must be tightly controlled.

Reference is made to the drawings that illustrate certain embodiments of the disclosure.

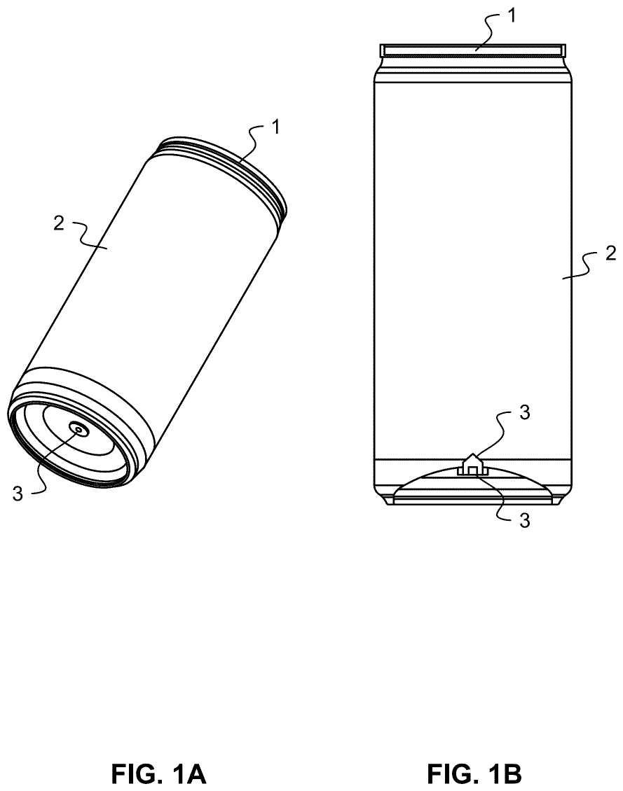

Referring now to FIGS. 1A and 1B, FIGS. 1A and 1B are a beverage container assembly 1 which includes a container body 2, an end, and a valve/grommet 3. In the figure, the container end is omitted for clarity to illustrate the valve/grommet. The beverage container is manufactured by any appropriate means including that disclosed in previously identified U.S.

U.S. Pat. Nos. 10,246,250 and 10,865,036, hereby incorporated for reference in their entirety. The manufactured beverage container is filled with liquid in a first facility by filling the container with a liquid and then sealing the container with an end or lid.

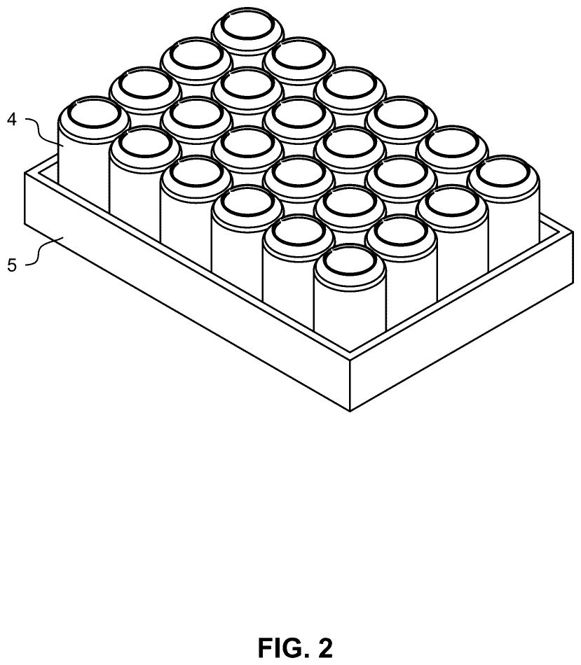

Referring now to FIG. 2, FIG. 2 shows one embodiment having an array of twenty-four beverage containers (4) placed in a disposable tray (5). It is common in the art for beverage containers to be packaged in trays as shown during production. The beverage containers are oriented such that the dosing valve is downward, and the end or lid of the container is upward. The trays of containers are then palletized for shipment to a second facility with the infusion of additives with the automated machine. The dosing valves are positioned downwards to protect them from collecting impurities during storage.

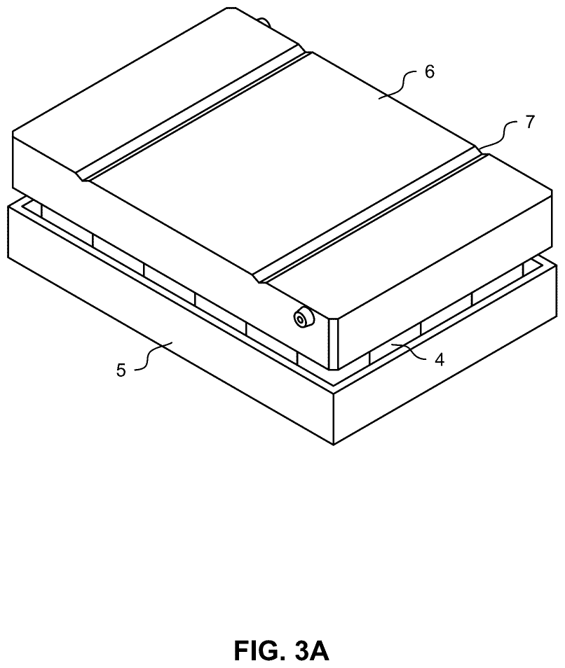

Referring now to FIGS. 3A, 3B and 3C, FIGS. 3A, 3B and 3C show the beverage containers in a tray now at the second facility wherein the dosing of additives with the automated machine will occur. In order for the automated machine to infuse additives into the container, the containers (4) must be inverted such that the dosing valves (3) are facing upwards. In addition, the containers must be transferred from the disposable tray (5) and placed in a reusable positioning tray (6) that precisely positions and constrains the containers (4). As illustrated in FIG. 3A, the positioning tray (6) is inverted and positioned above the tray of beverage containers. The positioning tray (6) is then lowered onto the beverage containers (4). At this point, the array of containers (4) can be inverted such that the disposable tray (5) is on top of the containers, and the positioning tray (6) is below the array of containers (4) as shown in FIG. 3B. At this point, the disposable tray can be removed as shown in FIG. 3C. The positioning tray holding the array of containers with the dosing valves upwards is now ready to be inserted into the automated machine. The positioning tray also has v-cut notches (7) on the bottom surface. The purpose of these v-cut notches is described later in this disclosure.

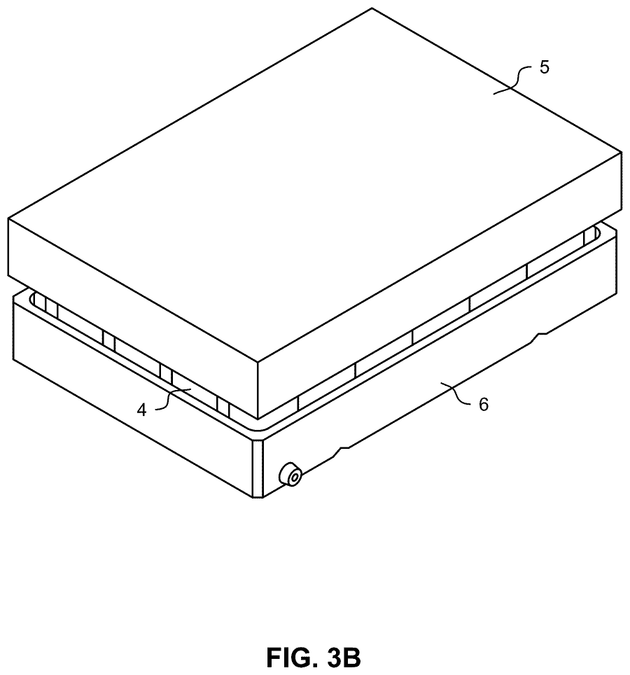

Referring now to FIG. 4, the automated machine (8) comprises a frame (9), electrical panel (10), enclosure (11), and conveyance track (12). While any suitable material can be employed, in one embodiment of the invention, the frame (9) is made from a mild steel tube with powder coating to prevent corrosion. In this embodiment, the enclosure (11) is made from aluminum extrusions (13) and tinted panels (14) to make it possible to see inside the enclosure. Tinting of the panels is employed to protect operators from ultraviolet light generated inside the enclosure (11). The ultraviolet light is discussed further in this disclosure. While any suitable material may be employed, polycarbonate is used for the tinted panels (14) in this embodiment. The conveyance track (12) allows trays of beverage containers (15) containing dosing valves (3) to be conveyed into the automated machine (8). An operator manually places trays of beverage containers onto the conveyance track, and the trays of beverage containers (15) are indexed into the machine wherein various operations are performed before a second operator on the opposite side of the machine removes the trays of beverage containers (15) from the conveyance track (12).

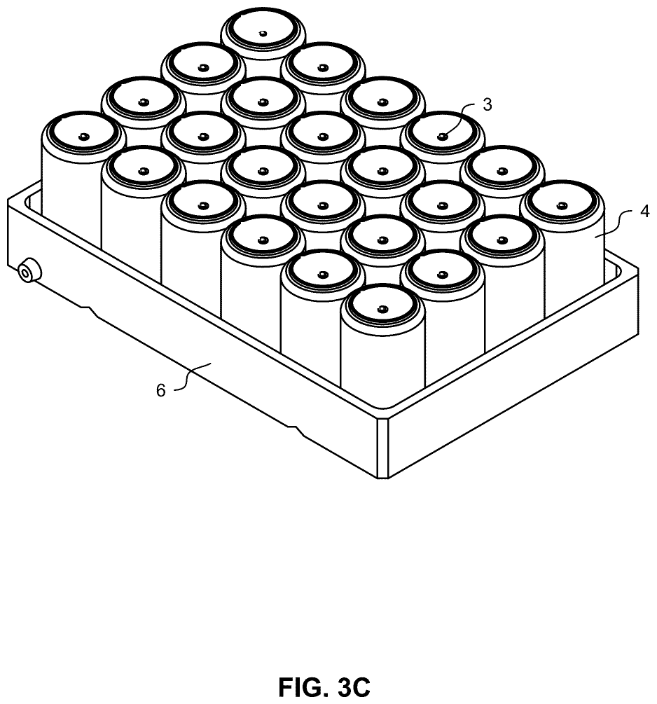

FIG. 5 is a side view of the automated machine (8) with the enclosure (11) hidden.

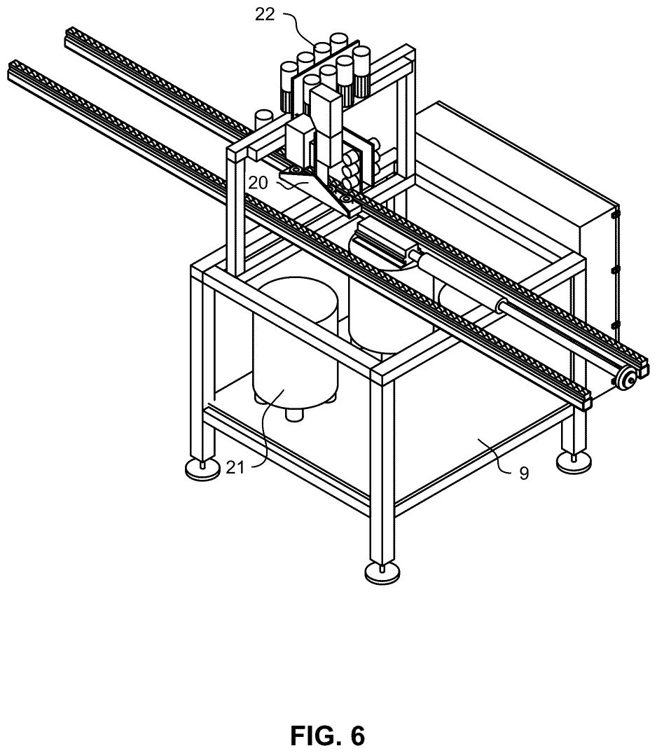

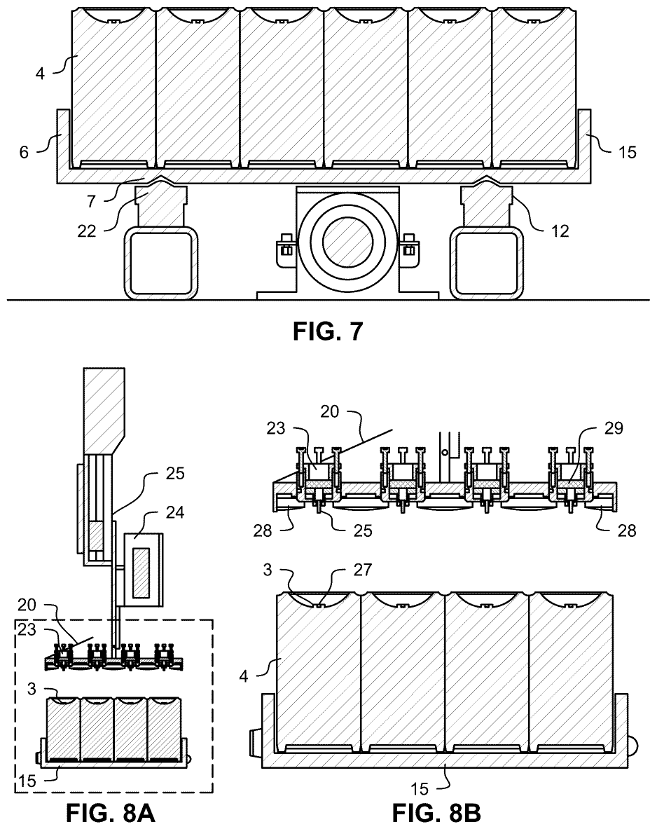

Referring now to FIGS. 4 and 5, the trays of beverage containers (15) are indexed along the conveyance track (12) by an actuator (16) with a platen (17) that contacts the tray of beverage containers (15) and slides them along the conveyance track (12). The actuator (16) must be sufficiently strong to push a series of trays of beverage containers (15) along the entire length of the conveyance track (12). While any actuation method can be employed, an electric powered actuator is employed. The benefit of an electric actuator in this embodiment is that the automated machine (8) can be installed in any facility without requiring special utilities such as dry compressed air. The actuator (16) operates in repetitive motion wherein the actuator indexes a tray along the conveyance track in a distance equal to the width of one tray. In this way, once the actuator returns to its initial position, an adequate space is made available for the operator to manually place an additional tray the cycle may repeat. In this way, the trays are able to progress continuously through the automated machine. An ionized air blower (18) is installed above the trays of beverage containers (15) with a flow of ionized air directed downwards to remove any loose dust or debris from the surfaces of the containers. The trays of beverage containers are pushed underneath the ionized air blower (18) by the actuator (16). The purpose of the ionized air blower (11) is to ensure no dust or debris is in the surfaces of the dosing valves prior to the dosing operation inside the enclosure (11). The next index cycle pushes the tray of beverage containers underneath an ultraviolet light array (19). The ultraviolet light array is contained within the enclosure (11) that has tinted panels (14). The ultraviolet light array is employed to sterilize the surface of the dosing valves. It is to be understood that any sterilizing means can be employed including solvent, steam, among others. Ultraviolet light is preferred in this embodiment because additional hardware including pumps, steam generators, valves, etc are not required and the machine does not require additional consumables. The tray of beverage containers is further indexed to the next position underneath the dosing head (20). In this index position, the beverage containers are dosed with an additive. The details of this dosing process are detailed in FIGS. 8a, 8b, and 9 which is discussed later in this disclosure.

After dosing is completed, the tray of the beverage container is indexed along the conveyance track until it is positioned outside the enclosure (11). In this index position, the second operator is able to remove the tray of beverages containers (15) from the conveyance track (12).

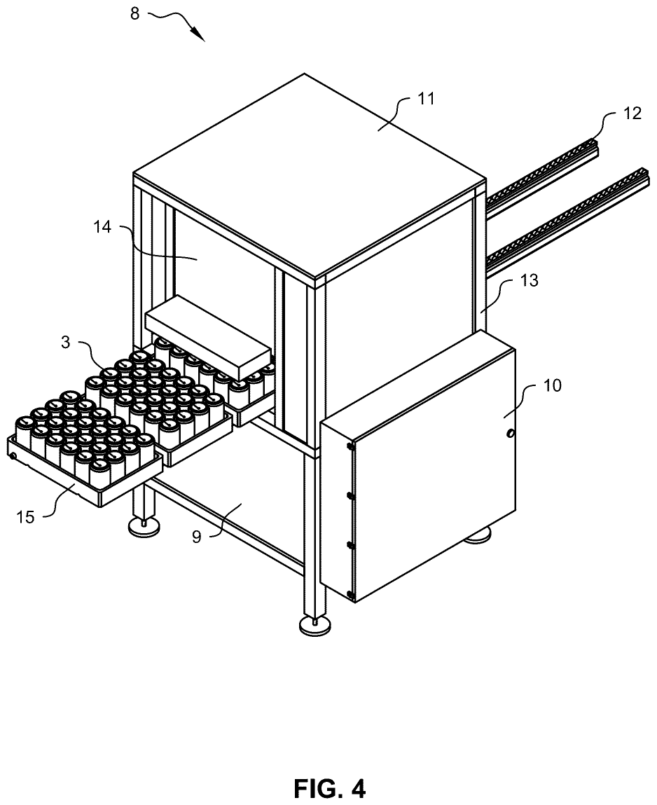

Referring now to FIG. 6, FIG. 6 shows the automated machine with a variety of components removed so that the inside of the machine can be seen. Inside the frame (9) are additive containers (15). The additive containers (21) are used to store the additive to be dosed into the beverage container. While any number of additive containers can be employed, three are used in this embodiment. The additive containers are connected to various pumps (22) in the dosing head (20) using hollow tubing. While any suitable material can be employed, in one embodiment of the invention, the tubing is made from Polytetrafluoroethylene (PTFE). PTFE is used in this embodiment due to its compliance with 21 CFR Parts 170-199 and chemical resistance to the preferred additives. The pumps (22) are then able to draw additives from the containers and pump the additives into the beverage containers through the dosing valves.

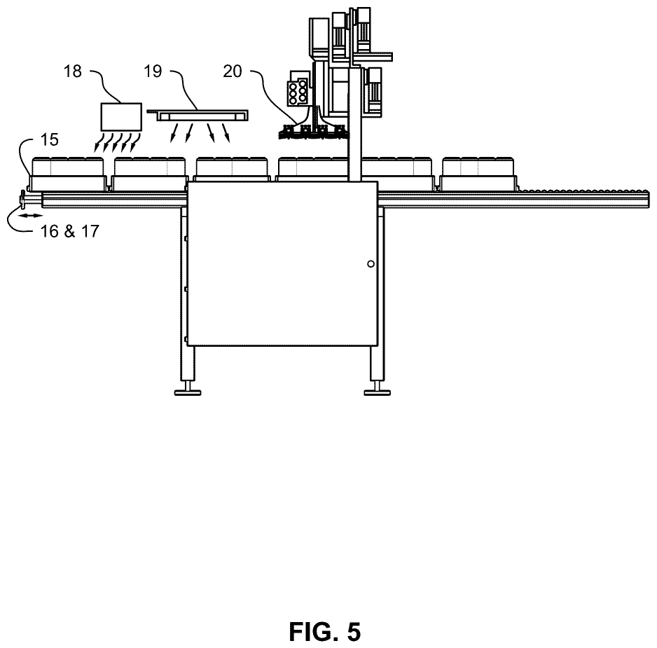

Referring now to FIG. 7, FIG. 7 shows a cross section of the tray of beverage containers (15) positioned on the conveyance track (12). The tray (6) that holds the beverage containers (4) is made with specific features to precisely locate the beverage containers. A V-shaped groove (7) is cut in the bottom of the tray along the axis of the conveyance track. The V-cut groove interfaces with spherical balls (22) positioned along the axis of the conveyance track. It is to be understood that any suitable mechanical constraint can be used. The V-cut and ball interface in this particular embodiment provides a mechanical constraint to the tray locking five degrees of freedom. The sixth degree of freedom remains unconstrained allowing motion of the tray of beverage containers along the axis of the conveyance rail. This particular mechanical constraint is critical to ensuring the dosing head can be repeatedly lowered onto the beverage containers without complex active alignment systems. The tray (6) is manufactured such that the beverage containers fit tightly in the tray to minimize positional variation of the beverage containers within the tray. In this specific embodiment, the tray is machined by computer numeric controlled (CNC) machining equipment from Acetal plastic, however a variety of manufacturing methods including injection molding, casting, 3D printing, among others can be used with a variety of materials including plastics, metals, or ceramics.

Referring now to FIGS. 8a and 8b, FIGS. 8a and 8b show a plurality of dosing nozzles (23) affixed to the dosing head (20). The dosing nozzles (23) are positioned such that each nozzle is aligned with the dosing valves (3). The dosing head (20) is mounted to a vertical (24) and horizontal stage (25) which is moveable. In this embodiment, the stages are electrically actuated with programmable positions to accommodate a plurality of container array sizes. While the stages in this embodiment are electrically actuated, any suitable stage could be employed including pneumatic, mechanical, and hydraulic, among others. Stage (24) moves along the vertical axis, while stage (25) moves along the horizontal axis. Now, with the tray of containers (15) positioned underneath the dosing head (20), the vertical stage (24) is moved vertically downward such that the dosing nozzles (23) contacts the dosing valves. A pin (26) on the dosing nozzle (23) first penetrates the bore (27) in the dosing valve. The dosing nozzles are made such that there is room for the dosing nozzle to move freely in both horizontal directions relative to the dosing head. In this way, the pin (26) guides the dosing nozzle (23) to the center axis of the dosing valve (3). This ensures that the dosing nozzle makes a seal on the dosing valve. Furthermore, the dosing head is made with chamfered lead-in features (28). The chamfered lead-in features (27) contact the circumference of each container (4) as the dosing head (20) moves downward along the vertical axis. This forces the containers to move toward the center axis of each dosing nozzle (23), which provides coarse alignment of the containers within the dosing head. The pin (26) and bore (27) then provides fine alignment of the dosing nozzle to the dosing valve. Each dosing nozzle is spring loaded (29) along the vertical axis. As the dosing head moves downward, and the dosing nozzles come in contact with the dosing valves, the springs (29) compress and exert a force on the dosing nozzles. When the dosing head reaches the final downward position, each spring is compressed enough to provide sufficient force to create a seal on the dosing valve. The springs are used in this embodiment to compensate for height tolerances and variation between each container. By using these springs, each dosing nozzle seals to each dosing valve, even if the container height varies and the dosing head is not perfectly aligned with the vertical axis.

Referring now to FIG. 9, the dosing head (20) is moved vertically downward to seal the dosing nozzles (23) to the dosing valves (3). In this position, the internal volume of the dosing nozzle is in fluid communication with the internal volume of the container. Each dosing nozzle has a threaded bore feature (30) wherein a tube can be connected to provide fluid communication between the dosing pump (22) and the dosing nozzle (23). With a tube connected between the pump and dosing nozzle, a positive pressure created by the pump that is in excess of the pressure of the container causes fluid to flow from the pump into the container (31). Pressure in the pump can be set from about 10 psi to about 150 psi, about 30 psi to about 100 psi, or preferably from about 60 psi to about 80 psi. The pressure in the container can vary from about 20 psi to about 60 psi. In this embodiment, the precise dosing is controlled by varying the displacement of the positive displacement pump to achieve any dosing desired. Once the dosing is completed, the dosing head moves upward a sufficient distance to provide clearance with the top plane of the containers. The horizontal stage then moves the dosing head to the next row of containers, and the cycle is completed.

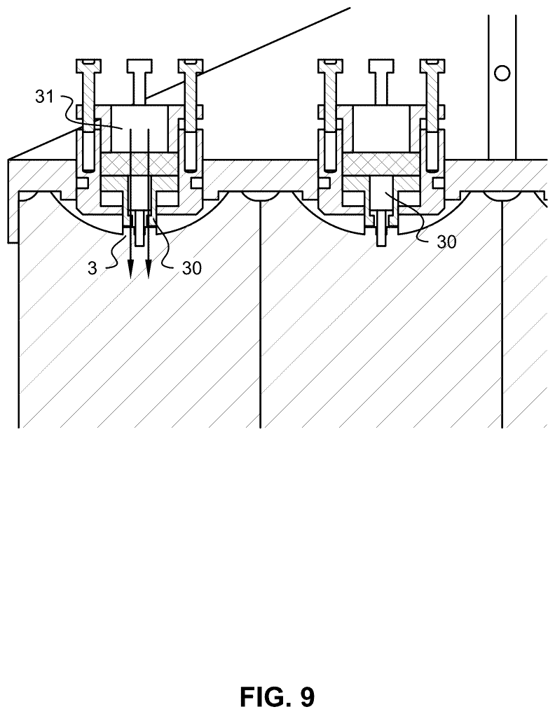

Referring now to FIG. 10, FIG. 10 shows a simplified flow diagram that illustrates the flow of liquid from bulk liquid storage vessels (32) to the dosing nozzles (23) on the dosing head (20). In a most basic example, the vessel (32) is in fluid communication with a pump (34), which is then in fluid communication with a dosing nozzle (23). In one embodiment, polytetrafluoroethylene plastic tubing (35) is used to connect the vessel to the pump, and the pump to the dosing valve. Various other components can be used in the system including check valves, solenoid valves, manifolds, etc., but will depend on the application. For precise dosing applications, it may be recommended that solenoid valves be used before and after the pump in place of check valves. In this preferred embodiment of the pump, a variable speed, variable displacement piston pump is used.

A second flow diagram is shown which is suitable for applications where multiple additive flow streams must be combined to dose the containers simultaneously. In this case, more than one additive storage vessel is used, and each storage vessel is in fluid communication with independent pumps so that the ratio of each additive can vary. Each pump is then in fluid communication with a common manifold wherein the additives are combined prior to flowing through the dosing valves. In this way, the flow streams are combined and mixed prior to entering the containers.

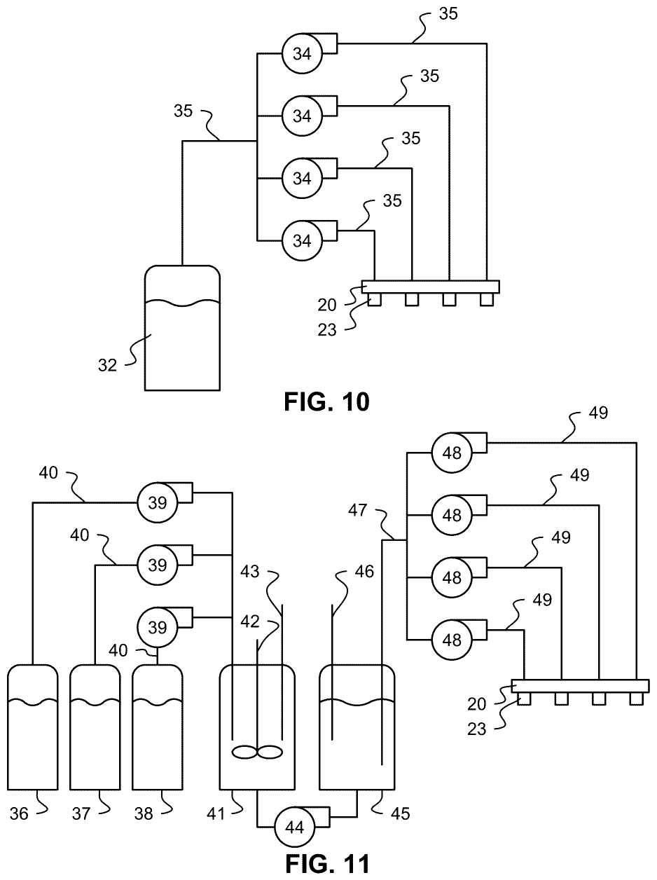

Referring now to FIG. 11, FIG. 11 shows a second flow diagram which is suitable for applications where multiple additive flow streams must be combined to dose the containers simultaneously. In this case, more than one additive storage vessel is used, and each storage vessel is in fluid communication with independent pumps so that the ratio of each additive can vary. Each pump is then in fluid communication with a common manifold wherein the additives are combined prior to flowing through the dosing valves. In this way, the flow streams are combined and mixed prior to entering the containers. This embodiment is preferred in applications where the volume of additive to be injected is smaller than the volume of the fluid path through the valve/grommet. In these instances, it is necessary to dilute the additive into a carrier fluid prior to dosing the machine. As an example, if 69 uL of additive is to be injected into the container, the additive must be diluted to allow for dosing of a large volume of liquid through the valve. Without dilution, more additives could be wasted as residue on the valve than actually passes through the valve. In this embodiment, two additives are combined with water, however any number of additives may be combined with any liquid. Containers 36, 37, and 38 are used to hold each additive and the diluent. Additive A, B and a diluent used in these embodiments. Each container is in fluid communication with the inlet of pumps 39 through tubes 40. The outlets of the pumps are in fluid communication with the inlet of a mixing vessel 41. The mixing vessel contains an agitator 42 and level probe 43. The outlet of the mixing tank is in fluid communication with the inlet of transfer pump 44. The outlet of transfer pump 44 is then in fluid contact with the inlet of buffer tank 45. Buffer tank 45 comprises a level probe 46 and an outlet tube 47. The outlet tube 47 is in fluid communication with the inlets of dosing pumps 48. The outlets of the dosing pumps are then in fluid communication with the dosing nozzles 23 through tube 49. In the initial state, the additive and diluent containers are filled. The mixing tank and buffer tank are empty. The mixing tank is first filled by pumping each additive and the diluent at the preferred ratio. For example, 69 ml of additive A, 69 ml of additive B, and 420 ml of diluent. The agitator is then turned on for a sufficient amount of time to create a homogeneous mixture. The transfer pump is then turned on to transfer the contents of the mixer to the buffer tank. The solution now contained in the buffer tank is instantly available for the dosing pumps to dose containers. The buffer tank volume is selected such that multiple containers can be dosed before the buffer runs out, providing time for the mixing tank to refill and transfer before the buffer runs out. While it can be sized for any number of doses, 100-200 doses are preferred in this embodiment. The cycle of filling the mixing tank and transferring to the buffer tank is then repeated continuously during production to continuously provide a diluted solution for dosing.

While any suitable components can be employed in connection with this invention, examples of suitable commercially available equipment components include:
1) precision pump and solenoid actuated valves: Lee Company,
2) pressure sensors: IFM Efector, Inc,
3) linear actuators: IAI America, Inc,
4) conveyance track: J.W. Winco, Inc
5) programmable logic controller: Allen Bradley, Automation Direct

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

1. A method for packaging a beverage in a beverage container, the method comprising:
filling and sealing a beverage container having a valve/grommet with a beverage to form a base beverage composition at a first facility;
transporting the beverage container to a second location remote from the first facility; and
dosing the base composition in the beverage container with an additive through the valve/grommet to form an infused beverage at the second facility.

2. The method of claim 1, wherein the additive is as regulated ingredient comprises a liquid emulsion of botanical extract.

3. A method for dosing a beverage in a beverage container, the method comprising:
providing a sealed beverage container containing a base composition, the sealed beverage container having a valve/grommet;
orienting the beverage container to align the valve/grommet with a dosing nozzle;
interfacing the dosing nozzle with the valve/grommet; and
injecting an additive into the beverage container through the valve/grommet with the dosing nozzle.

4. The method of claim 3, further comprising directing an air blower toward the valve/grommet to remove dust and debris.

5. The method of claim 3, further comprising directing an ultraviolet light array to sterilize the valve/grommet prior to injecting.

6. A self-contained and easily transportable apparatus for dosing a previously sealed beverage container having a valve/grommet comprising:
a conveyance arranged and disposed to position an orientable fixture for positioning the beverage containers and the valve/grommet;
at least one dosing head having at least one dosing nozzle; and
at least one vessel in selective liquid communication with the dosing nozzle to inject additive into the sealed beverage container;
wherein the dosing nozzle is actuatable to interface the dosing nozzle with the valve/grommet and inject the additive into the beverage container from the at least one vessel through the valve/grommet.

7. The apparatus of claim 6, further comprising an air blower arranged and disposed to remove dust and debris from the valve/grommet.

8. The apparatus of claim 6, further comprising an ultraviolet light array arranged and disposed to sterilize the valve/grommets prior to the injection of the additive.

9. The apparatus of claim 6, wherein the at least one vessel includes a plurality of vessels, each vessel including an independent additive to be combined to dose the beverage container.

10. The apparatus of claim 9, wherein each storage vessel is in fluid communication with independent pumps and the dosing nozzle to vary the ratio of each additive dosed to the beverage container.
